(19) United States
(12) Patent Application Publication
(10) Pub. No.: US 2011/0228833 A1
(43) Pub. Date: Sep. 22, 2011

(54) WIRELESS COMMUNICATION APPARATUS, SIGNAL PROCESSING METHOD, AND NON-TRANSITORY COMPUTER READABLE MEDIUM

(75) Inventor: Tatsuhito SAITOU, Kanagawa (JP)

(73) Assignee: RENESAS ELECTRONICS CORPORATION, Kanagawa (JP)

(21) Appl. No.: 13/051,540

(22) Filed: Mar. 18, 2011

(30) Foreign Application Priority Data
Mar. 18, 2010 (JP) 2010-062570

(51) Int. Cl. H04B 17/00

(52) U.S. Cl. 375/224; 375/316

(57) ABSTRACT

A wireless communication apparatus receives a signal with a no signal section inserted between OFDM symbols and includes an overlap addition number table unit and an overlap addition unit. The overlap addition number table unit associates band information specifying a frequency band to transmit a signal and an overlap addition number specifying a number of samples in the no-signal section to be overlap-added to an OFDM symbol. The overlap addition unit adds data to a beginning of the OFDM symbol using the overlap addition number table, the data corresponding to the overlap addition number determined according to the band information.

### CROSS-REFERENCE TO RELATED APPLICATIONS

This application is based upon and claims the benefit of priority from Japanese patent application No. 2010-062570, filed on Mar. 18, 2010, the disclosure of which is incorporated herein in its entirety by reference.

### BACKGROUND

The present invention relates to a UWB (Ultra Wide Band) communication using Multi Band OFDM (Orthogonal Frequency Division Multiplexing) system, and particularly to improvement in communication characteristics of UWB communication.

In recent years, the UWB device using the Multi Band OFDM (hereinafter referred to as “MB-OFDM” as appropriate) system is spreading along with the spread of communication device, such as a Wireless USB. As the communication distance is about 10 m which is shorter than other wireless communications, the communication distance must be extended by improving the communication characteristics. In addition to the extension request for the communication distance, there has been an increasing request to reduce the cost of the UWB wireless communication apparatus along with reduced price of the communication device such as a wireless USB.

In the wireless communications, in order to reduce the influence of multipath fading, a guard interval is inserted in a transmission signal or adaptive equalization reception is performed by the receiving side.

For example, in the Near Field Communication standard UWB, which is standardized by ECMA (European Computer Manufacturer Association) as ECMA-368, and adopts MB-OFDM as a PHY layer, as shown in FIG. 5, a zero suffix (ZS) for 37 samples is inserted behind an OFDM symbol of 128 samples, which is generated by IFFT (Inverse Fast Fourier Transform). A UWB transmission apparatus superimposes the transmission data with the zero suffix inserted on a carrier, and transmits the data.

A UWB reception apparatus receives the signal with the zero suffix inserted, and adds the data of the zero suffix section (no-signal section) added behind the OFDM symbol to the beginning of the OFDM symbol. Such addition process is hereinafter referred to as “an overlap addition process”. By the overlap addition process of the UWB reception apparatus, the influence of the multipath fading in the transmission path between the UWB transmission apparatus and the UWB reception apparatus can be compensated. Since the time for five zero suffix among 37 zero data inserted as the zero suffix is assigned to the switching time of the carrier frequency in the reception apparatus, the number of samples used for the overlap addition will be 32.

FIG. 6 shows a configuration of a UWB reception apparatus disclosed in Japanese Unexamined Patent Application Publication No. 2007-336312. In FIG. 6, a band pass filter (BPF) 12 makes a band selection of a signal received by an antenna 11, and a low noise amplifier (LNA) 13 amplifies the signal. The BPF 12 is a filter for removing out-of-band noise and interference waves. The signal amplified by the LNA 13 is output to a quadrature demodulation unit 14 to be quadrature demodulated. Note that since frequency hopping is performed in the MB-OFDM, a local frequency fc, which is generated by an oscillator not shown and is output to the quadrature demodulation unit 14, is periodically switched according to a frequency hopping pattern.

The low pass filter (LPF) 15 removes the high-frequency component from a baseband signal demodulated by the quadrature demodulation unit 14. Then a variable gain amplifier (VGA) 16 amplifies the baseband signal to a predetermined signal level.

An ADC (ADC) 17 inputs the baseband signal amplified by the VGA 16, performs sampling and quantization, and outputs the digitized discrete baseband signal. The output signal from the ADC 17 is output to a synchronous processing unit 18.

The synchronous processing unit 18 removes a preamble and performs a phase rotation process for correcting a phase error between the carrier frequency of the reception signal and the local frequency used for quadrature demodulation to the input baseband signal, while catching symbol synchronous timing and frame synchronous timing of the OFDM signal. Note that the synchronous processing unit 18 includes a correlator (not shown) which calculates a correlation value between an input signal and a known preamble signal. The synchronous processing unit 18 determines the symbol synchronous timing of the OFDM signal based on a peak position of the correlation value calculated by the correlator.

An FFT unit 20 performs fast Fourier transform to the baseband signal which is overlap-added, and outputs demodulated data for each subcarrier.

A subcarrier decoding unit 21 performs frequency equalization process, deinterleaving, Viterbi decoding, and descrambling or the like to the demodulated data for each subcarrier using a pilot tone, and outputs the obtained decoded data.

A delay spread estimation unit 22 calculates a delay spread of the reception signal. The delay spread is an evaluation parameter reflecting a spread of time delay of the reception signal by propagation of multipath. An overlap addition number determination unit 23 determines an overlap addition number according to the delay spread calculated by the delay spread estimation unit 22. The overlap addition number is the number of samples in the zero suffix section in which the overlap addition is performed to the OFDM symbol by the overlap addition unit 19. In the case of the UWB reception apparatus which adopted the OFDM system, the maximum value of the overlap addition number is 32, and the minimum is zero.

The overlap addition unit 19 adds the data of the zero suffix section to a beginning of the OFDM symbol section while removing the zero suffix section from the input baseband signal. Note that the data length of the zero suffix section, which is overlap-added by the overlap addition unit 19, that is the number of samples, can be changed according to the overlap addition number determined by the overlap addition number determination unit 23.

The overlap addition process performed by the overlap addition unit 19 is represented by a following formula (1). In this formula, NOAA is an overlap addition number determined by the overlap addition number determination unit 23, and in the case of an OFDM reception apparatus, it is 0<=N_{OAA}<=32.

$${S}_{out} [ k ] = \{ \begin{matrix}Sn [ k ] + Sn [ k + 128 ] & k ∈ [ 0 , {N}_{OAA} - 1 ] \\ Sn [ k ] & k ∈ [ {N}_{OAA} , 127 ]\end{matrix} \qquad ( 1 )$$

Thus, the UWB reception apparatus 1 of FIG. 6 can change the data length of the zero suffix section which is overlap-added according to the size of the delay spread.

FIG. 7 shows a configuration of the delay spread estimation unit 22 and overlap addition number determination unit 23. The delay spread estimation unit 22 of FIG. 7 is composed of a correlator 31, adders 321 to 323, multipliers 324 to 327, and delay circuits 328 and 329. The delay circuits 328 and 329 generate delay for one sample. The correlator 31 calculates a correlation value between an input signal and a known preamble, more specifically a packet synchronizing sequence in the preamble.

The adders 321 to 323 of FIG. 7, the multipliers 324 to 327, and the delay circuits 328 and 329 are circuits for calculating distribution σ² of an output of the correlator 31 shown in a formula (2). That is, the delay spread estimation unit 22 of FIG. 7 estimates the delay spread by the distribution σ² of the output of the correlator 31. In the formula (2), xi is an output value of the correlator 31, and n is the number of samples used for the calculation of the distributed σ². The number of samples n is represented by a formula (4) using a sampling frequency fx [Hz] of the correlator 31 and a maximum allowed value Tsp used of the square root RDS of the delay spread. Although the maximum allowed value of RDS changes according to the communication distance, in UWB, it is defined as Tsp=26 ns as a standard. In this case, if the sampling frequency of the correlator 31 is 528 MHz, the number of samples n is 14.

$$\begin{matrix}{σ}^{2} = \frac{n {\sum }_{i = 1}^{n} {x}_{i}^{2} - {( {\sum }_{i = 1}^{n} x )}^{2}}{n ( n - 1 )} & ( 2 ) \\ n = fs \times Tsp & ( 3 )\end{matrix}$$

On the other hand, the overlap addition number determination unit 23 shown in FIG. 6 includes a comparator 33. The comparator 33 compares the delay spread calculated by the delay spread estimation unit 22 with a square of a threshold Cth, and outputs a comparison result as a control signal S1. A multiplier 34 is provided in order to calculate the square of threshold Cth.

The threshold Cth can be determined by the following formula (4). In the formula (4), Tth is a threshold for switching of the overlap addition number, and the unit is expressed in seconds. Specifically, if the square root RDS of the delay spread calculated for the reception signal is Tth or greater, the signal S1 will be high level, and if the square root RDS is Tth or smaller, the signal S1 will be low level.

Cₜₕ=Tₜₕ×fs (4)

The overlap addition unit 19 selects whether to perform the overlap addition to the latter 16 samples of the zero suffix according to the control signal S1 output by the overlap addition number determination unit 23.

According to the configuration explained with reference to FIG. 6, the overlap addition unit 19 can perform the overlap addition to 32 samples in the zero suffix section if the delay spread is greater than a predetermined threshold, and perform the overlap addition to only 16 samples in the zero suffix section if the delay spread is smaller than the predetermined threshold.

The combination of the threshold and the overlap addition number for the size of the delay spread should be an appropriate value that is determined by a simulation or LSI evaluation. Further, the configuration explained with reference to FIG. 6 is merely an example. The overlap addition number may be other than 16 or 32, and the overlap addition number may be selected from more than three kinds of values according to the size of the delay spread. For example, the overlap addition number determination unit 23 selects three kinds of the overlap addition number, which are 8, 16, or 32, according to whether the square root RDS of the delay spread is less than 5 ns, 5 to 10 ns, or 10 ns or greater. The overlap addition unit 19 may perform the overlap addition based on the selected overlap addition number.

As described above, various methods can be considered for determining the overlap addition number according to the size of the delay spread. However as it is necessary to gradually increase the overlap addition number as the delay spread increases, typically the overlap addition number applied to the overlap addition unit 19 may be monotonically increased according to the size of the delay spread.

Further, although FIG. 7 shows a configuration example of realizing the delay spread estimation unit 22, the overlap addition number determination unit 23, and the overlap addition unit 19 as dedicated circuits, the processes can be realized by DSP (Digital Signal Processor). Furthermore, the above processes can be realized by executing software describing the processes performed by the delay spread estimation unit 22, the overlap addition number determination unit 23, and the overlap addition unit 19 on a computer system.

Next, an effect of improving the communication characteristics in the UWB reception apparatus by changing the overlap addition number according to the amount of the delay spread is explained hereinafter. If 32 samples data in the zero suffix section is always to be overlap-added, even when the delay spread of the reception signal is small, noise for 32 samples is added to the OFDM symbol. The penalty for adding the noise for 32 samples is 10 log 10(160/128)=0.97 dB, and necessary CNR (Carrier to Noise Ratio) will deteriorate by about 0.97 dB due to the overlap addition.

On the other hand, when the overlap addition number is adoptively changed according to the size of the delay spread, which is when the delay spread is small as shown in FIG. 8, only the section corresponding to a part of the 32 samples zero suffix section (ZS section), which is an addition section shown in FIG. 8, instead of the entire 32 samples zero suffix section, is added to the beginning of received data 82 in an FFT section. Then, as shown in FIG. 9, noise 84 which is added to the received data 82 is smaller than in the configuration of always adding noise for 32 samples.

### SUMMARY

The present inventor has found a problem in the related art that in order to improve the communication distance, the circuit size of the semiconductor apparatus increases. The reason is that it is necessary to mount on a UWB wireless communication apparatus the circuit to estimate the amount of delay spread and the overlap addition number determination circuit that determines the overlap addition number from the estimated amount of delay spread in order to perform multipath fading compensation according to the amount of delay spread. Therefore, the circuit size cannot be reduced.

An aspect of the present invention is a wireless communication apparatus that receives a signal including a no-signal section inserted between OFDM symbols, the wireless communication apparatus including an overlap addition number table and an overlap addition unit. The overlap addition number table unit associates band information which specifies a frequency band to transmit a signal, and an overlap addition number which specifies the number of samples in the no-signal section, which is overlap-added to the OFDM symbol. The overlap addition unit adds data to a beginning of the OFDM symbol using the overlap addition number table, the data corresponding to the overlap addition number determined according to the band information. The overlap addition number table holds a combination of the band information and the overlap addition number. The overlap addition number table eliminates the need to calculate the amount of delay spread. Thus the circuit for calculating the delay spread can be removed.

Another aspect of the present invention is a signal processing method of a wireless communication apparatus that receives a signal with a no-signal section inserted between OFDM symbols, the signal processing method including: holding a combination of band information and an overlap addition number, in which the combination associates the band information that specifies a frequency band to transmit the signal and the overlap addition number that specifies the number of samples in the no-signal section to be overlap-added to an OFDM symbol; and determining the overlap addition number according to the band information using the combination of the band information and the overlap addition number.

Another aspect of the present invention is a non-transitory computer readable medium storing a program that when executed by a computer, causes the computer to execute a process for a wireless communication apparatus that receives a signal with no-signal section inserted between OFDM symbols to process the signal, the process including: holding a combination of band information and an overlap addition number in a memory, in which the combination associates the band information that specifies a frequency band to transmit the signal with the overlap addition number that specifies a number of samples in the no-signal section to be overlap-added to an OFDM symbol; and determining the overlap addition number according to the band information using the combination of the band information and the overlap addition number.

According to the present invention, it is possible to reduce the circuit size of a wireless communication apparatus.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing an example of a configuration of a UWB reception apparatus according to a first embodiment of the present invention;

FIG. 2 illustrates an example of an overlap addition number table unit of the UWB reception apparatus according to the present invention;

FIG. 3 illustrates a configuration of a frequency channel in the UWB of the Multi Band OFDM system;

FIG. 4 is a block diagram showing an example of a configuration of a UWB reception apparatus according to a second embodiment of the present invention;

FIG. 5 illustrates a transmission data format of UWB;

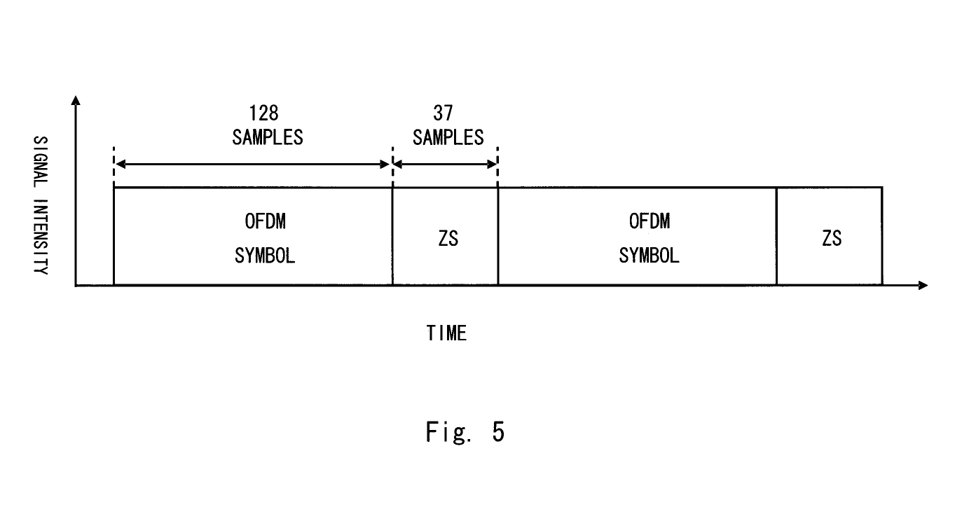

FIG. 6 is a configuration diagram of a UWB reception apparatus according to a related art;

FIG. 7 explains a specific configuration example of the UWB reception apparatus according to the related art;

FIG. 8 explains an effect of the related art; and

FIG. 9 explains the effect of the related art.

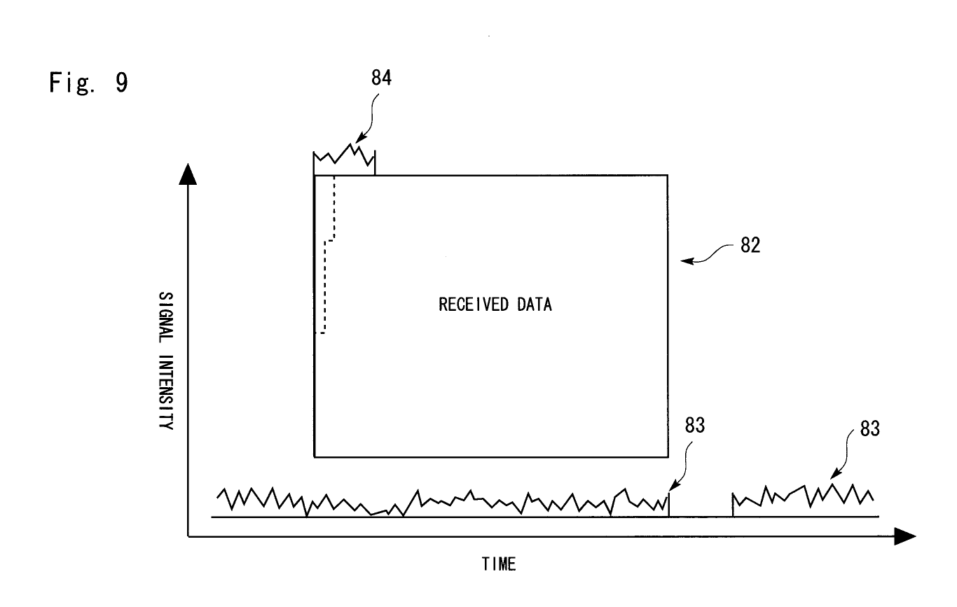

### DETAILED DESCRIPTION

Hereinafter, embodiments of the present invention are described with reference to drawings. For the clarification of the explanation, the following descriptions and drawings are omitted and simplified as appropriate. In the drawings, the same or corresponding components having the same configuration or function are denoted by the same reference signs, and the explanation is omitted.

The present invention can be applied to the wireless communication apparatus which receives a signal with a no-signal section inserted between OFDM symbols. In this specification, the term “the no-signal section” refers to a signal section where no significant signal exists at the time of transmission, such as the zero-suffix section and zero prefix section. The term “the OFDM symbol” refers to a section where a significant signal exists, that is, a signal section for transmitting desired data. The OFDM symbol is also referred to as a desired signal section.

In the following embodiments, although it will be explained using a UWB reception apparatus as an example of the wireless communication apparatus, it is not limited to this. The present invention can be applied to an apparatus that receives the signal with the no-signal section inserted and performs the overlap addition process.

An aspect of the wireless communication apparatus (reception apparatus) of the present invention determines an overlap addition number according to the band information in communications for transferring the signal while inserting the no-signal section in the OFDM symbol. Specifically, the wireless communication apparatus includes a means to determine the overlap addition number according to the band information using the overlap addition number table unit. The band information specifies a frequency channel used for signal transmission, which is specifically, a band ID (IDentifier) or a band group.

### First Embodiment

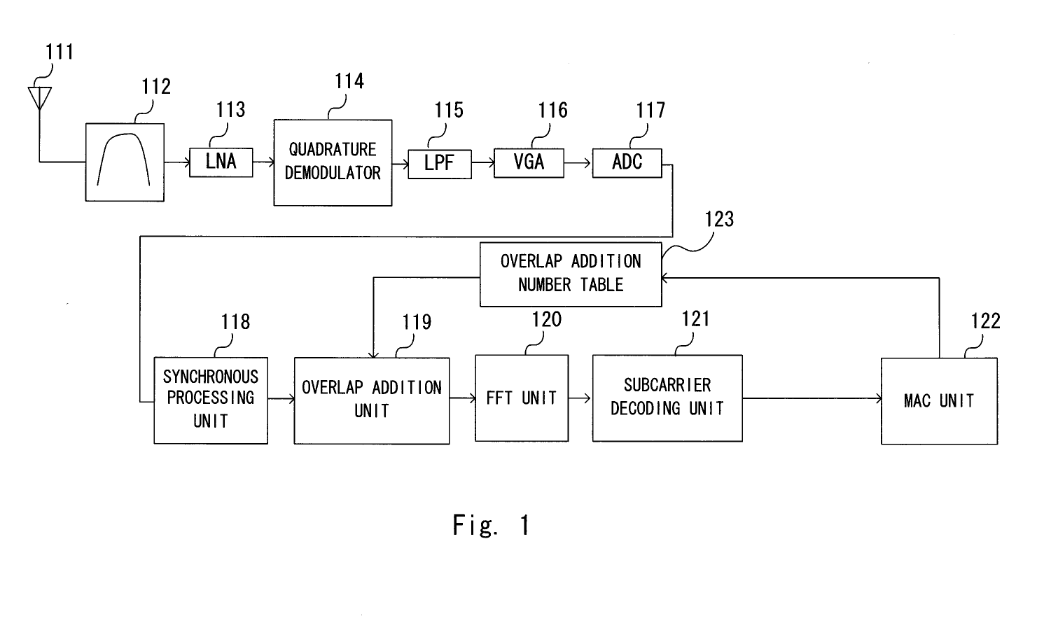

FIG. 1 is a block diagram showing a system configuration example of a UWB reception apparatus using the Multi Band OFDM system.

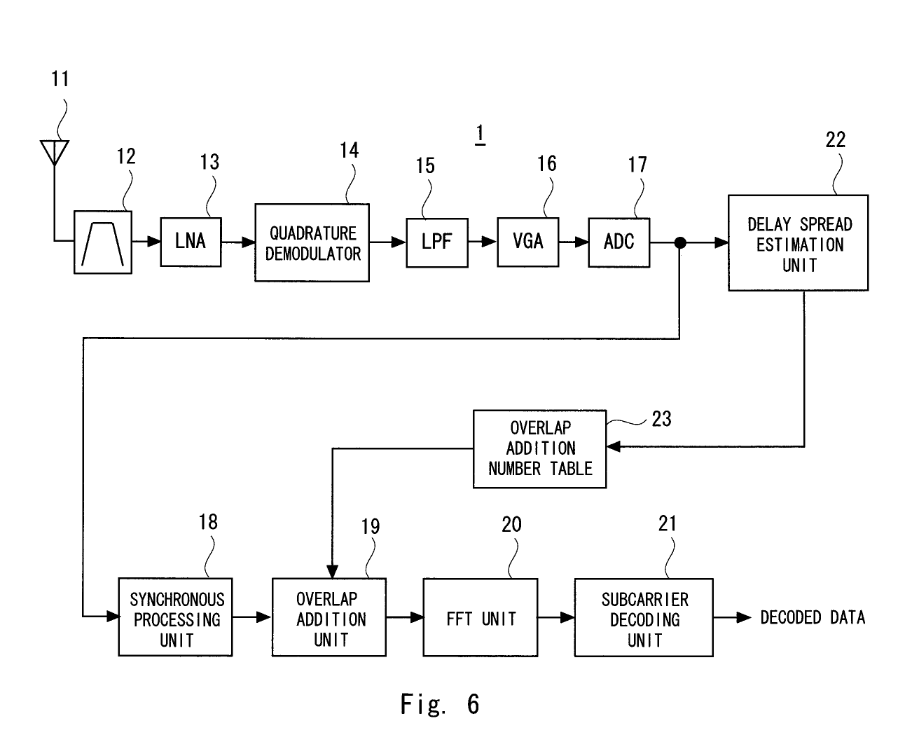

The UWB reception apparatus system using the Multi Band OFDM system includes an antenna 111, a band pass filter (BPF) 112, a low noise amplifier (LNA) 113, a quadrature demodulation unit 114, a low pass filter (LPF) 115, a variable gain amplifier (VGA) 116, an A/D converter (ADC) 117, a synchronous processing unit 118, an overlap addition unit 119, an FFT unit 120, a subcarrier decoding unit 121, and a media access controller unit 122 (hereinafter referred to a MAC unit), and an overlap addition number table unit 123. The configurations from the antenna 111 to the ADC 117 are the same as FIG. 6, and will be explained in the operations described later.

The synchronous processing unit 118 receives the baseband signal output from the A/D converter (ADC), and outputs the baseband signal with a preamble removed and a phase rotated to the overlap addition unit 119.

The overlap addition unit 119 receives the baseband signal with a preamble removed and a phase rotated output from the synchronous processing unit 118, and the overlap addition number output from the overlap addition number table unit 123. Then, the overlap addition unit 110 removes the zero suffix section from the baseband signal received from the synchronous processing unit 118, and outputs the baseband signal, in which the data corresponding to the overlap addition number among the data for 32 samples in the zero suffix section is added to the beginning of the OFDM symbol section, to the FFT unit 120.

The FFT unit 120 receives the baseband signal output from the overlap addition unit 119, and demodulates the received baseband signal, and outputs the demodulated data to the subcarrier decoding unit 121.

The subcarrier decoding unit 121 receives the demodulated data output from the FFT unit 120, and outputs the decoded data to the MAC unit 122.

The MAC unit 122 receives the decoded data output from the subcarrier decoding unit 121, and outputs a band ID signal to the overlap addition number table unit 123.

The overlap addition number table unit 123 receives the band ID signal S0 output from the MAC unit 122, and outputs an overlap addition number 51 to the overlap addition unit 119. In the first embodiment, it is assumed that the overlap addition number table unit 123 is composed of hardware, and is placed inside the same LSI (Large Scale Integration) where the overlap addition unit 119 is placed.

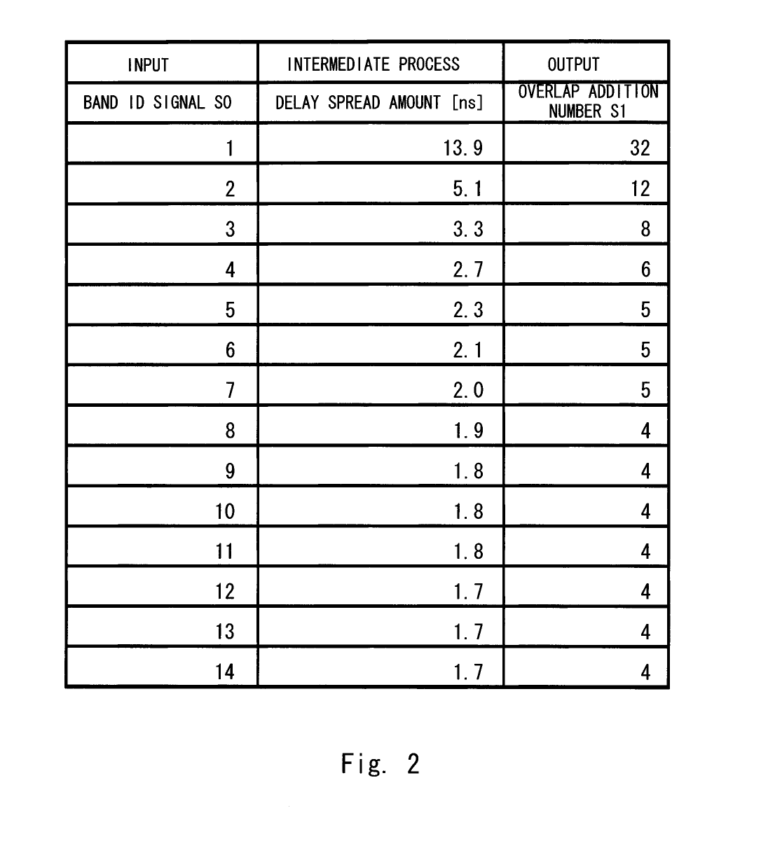

FIG. 2 shows a table indicating the overlap addition number for every band ID as an example of the overlap addition number table unit. The overlap addition number table unit includes input values of the band ID signal S0, amounts of delay spread calculated in an intermediate process, and output values of the overlap addition number S1. The overlap addition table unit has an output value (overlap addition number 51) for each band ID signal to be input. FIG. 2 shows a case in which the overlap addition number table unit 123 holds the amount of delay spread, however it is shown for easier explanation. The overlap addition number table unit 123 does not need to hold the amount of delay spread as long as the band information can be associated with the overlap addition number.

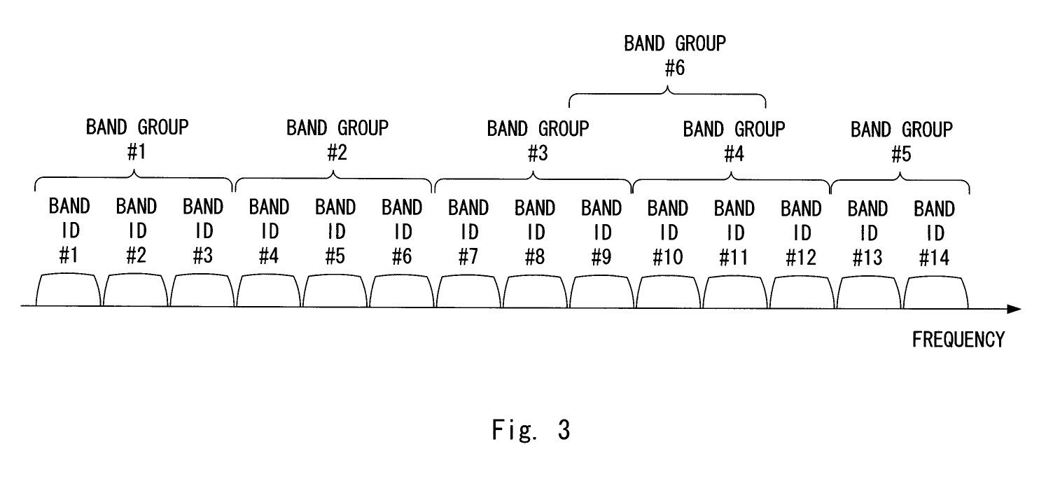

The band ID is explained hereinafter. FIG. 3 illustrates a configuration of a frequency channel in the Multi Band OFDM system. The frequency channels are assigned from band ID#1 to band ID#14. Further, the band group grouping three bands is assigned from #1 to #6. In this embodiment, the band ID is used as the band information. As shown in FIG. 2, a case of associating the overlap addition number with the band ID is explained.

Next, an operation of the wireless reception apparatus of this embodiment is explained with reference to FIGS. 1 to 3.

The band pass filter (BPF) 112 makes a band selection of the signal received by the antenna 111, and outputs the signal to the LNA 113. At this time, the BPF 112 selects the band ID to be received from a plurality of MB-OFDM band IDs, and removes out-of-band noise and interference waves.

The LNA 113 amplifies the signal with the band selected, and outputs the signal to the quadrature demodulation unit 114.

The quadrature demodulation unit 114 quadrature demodulates the signal amplified by the LNA 113.

After the LPF 115 removes a high frequency component from the baseband signal demodulated by the quadrature demodulation unit 114, and then outputs the baseband signal to the VGA 116.

The VGA 116 amplifies the baseband signal received from the quadrature demodulation unit 114 to a predetermined signal level, and outputs the baseband signal to the ADC 117.

The ADC 117 inputs the baseband signal amplified by the VGA 116, samples and quantizes the baseband signal, and outputs the digitized discrete baseband signal to the synchronous processing unit 118.

The synchronous processing unit 118 removes a preamble and performs the phase rotation process to the received baseband signal while catching a symbol synchronous timing and frame synchronous timing of the OFDM signal. The phase rotation process corrects a phase error between the carrier frequency of the reception signal and the local frequency used for quadrature demodulation. The synchronous processing unit 118 determines the symbol synchronous timing of the OFDM signal based on the peak position of the correlation value calculated by the correlator.

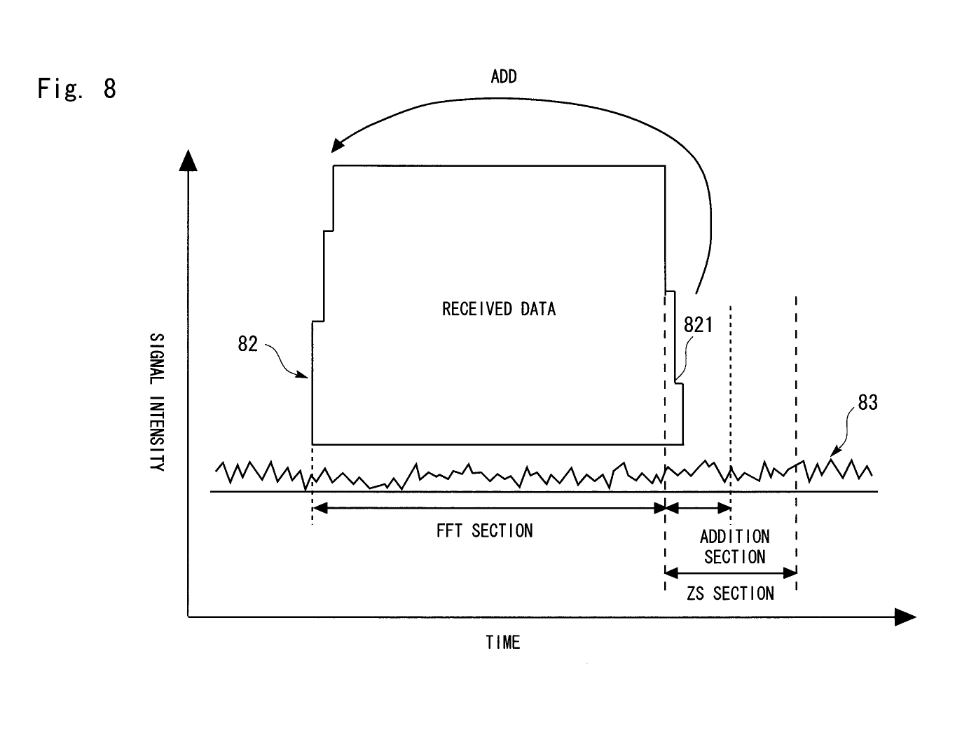

An operation of the overlap addition unit 119 is the same operation as the related art, and is explained with reference to FIG. 8. The overlap addition unit 119 removes the zero suffix section (ZS section of FIG. 8) from the input baseband signal. At the same time, the overlap addition unit 119 adds the data length according to the overlap addition number determined by the overlap addition number table unit 123 among the zero suffix section, which is the signal of the number of samples, to the beginning of the OFDM symbol section, and outputs the signal to the FFT unit 120.

The FFT unit 120 performs fast Fourier transform to the overlap-added baseband signal, and outputs the demodulated data for each subcarrier.

The subcarrier decoding unit 121 performs frequency equalization process, deinterleaving, Viterbi decoding, and descrambling or the like to the demodulated data for each subcarrier using a pilot tone, and outputs the obtained decoded data.

In response to the decoded data, the MAC unit 122 outputs the decoded data to a host computer via an interface such as PCI (Peripheral Component Interconnect) and USB. The MAC unit 122 performs communication protocol control, assigns a frequency channel for each communication apparatus, and enables simultaneous communication. The MAC unit 122 outputs the band ID and the band group information which indicate the assigned frequency channel to the overlap addition number table unit 123. In this embodiment, since the overlap addition number table unit 123 associates the band ID and the overlap addition number, an example is shown in which the MAC unit 122 outputs the band ID to the overlap addition number table unit 123. If the overlap addition number table unit 123 associates the band group, instead of the band ID, with the overlap addition number, the band group information will be output to the overlap addition number table unit 123. Therefore, the MAC unit 122 should output the band information including at least one of the band ID and the band group information to the overlap addition number table unit 123.

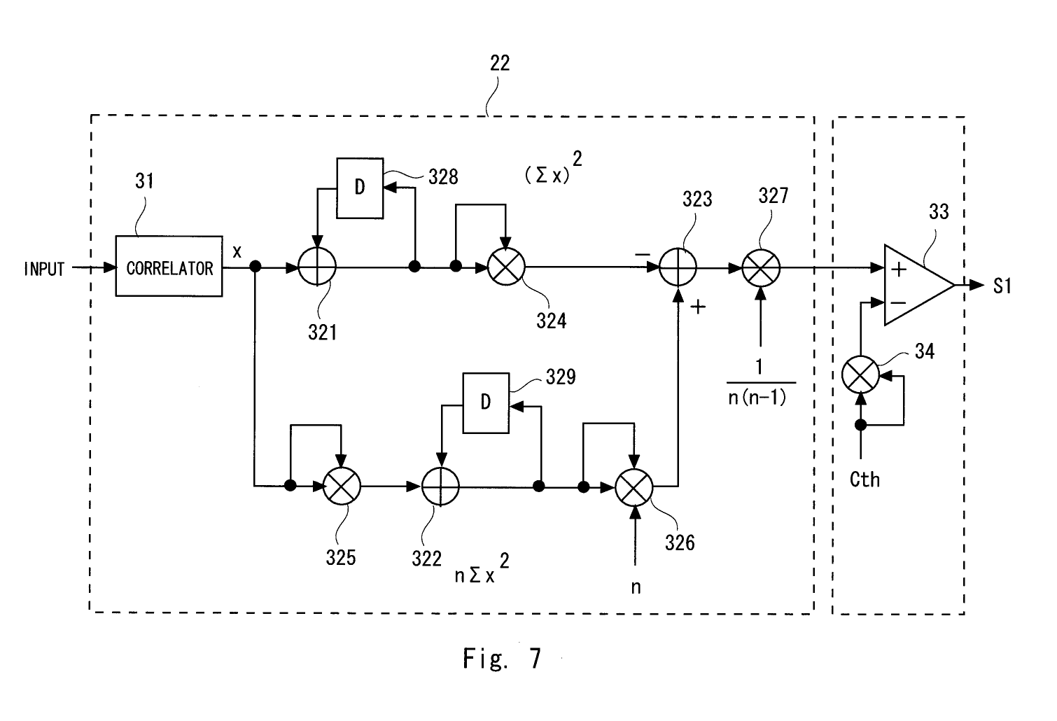

The overlap addition number table unit 123 outputs the overlap addition number to the overlap addition unit 119 according to the correlation between the band ID signal and the amount of delay spread used in the communication of FIG. 2. The overlap addition number table unit 123 associates the band information and the overlap addition number and holds them. The procedure for determining the overlap addition number according to the band information is explained hereinafter. The correlation of the band information and the delay spread is used to determine (calculate) the overlap addition number according to the band information. When creating the overlap addition number table unit 123, the values or the like for an examination, which are calculated from past record values and a simulation in a similar wireless communication apparatus, can be used for the amount of delay spread. In this case, the value calculated by the delay spread estimation unit 22 shown in FIG. 7, for example, can also be used.

The correlation of the band ID and the amount of delay spread is explained with reference to FIG. 2. The amount of delay spread is calculated using the formula explained below.

The arithmetic expression of the propagation loss of waves in a free space is formula (5), with propagation loss [dB], carrier frequency f [MHz], and communication distance d [m].

loss=20 log(f)+20 log(d)−27.6 (5)

The maximum transmission power in the standard of UWB using the Multi Band OFDM system is −14 dBm. Thus electric power powf of a reflected wave which reaches the reception apparatus (reception unit) is represented by a formula (6) using a path distance df of the reflected wave and the formula (5).

powf=−14 dBm−(20 log(f)+20 log(df)−27.6) (6)

The output value output from the correlator 31 of FIG. 7 shall be a correlator output x. Distribution 6 of the correlator output x indicating the amount of delay spread is represented by distribution of a correlator output xi in sampling time i as shown in the formula (2). The wireless communication apparatus receives a direct wave and a reflected wave. The formula (2) can be represented by a formula (7) when using a correlator output X_{d} of the direct wave and a correlator output X_{f} of the reflected wave.

$$\begin{matrix}{σ}^{2} = \frac{n ( {X}_{d}^{2} + {X}_{f}^{2} ) - {( {X}_{d} + {X}_{f} )}^{2}}{n ( n - 1 )} \\ = \frac{( n - 1 ) {X}_{d}^{2} + ( n - 1 ) {X}_{f}^{2} - 2 {X}_{d} {X}_{f}}{n ( n - 1 )} \\ = \frac{{X}_{d}^{2} + {X}_{f}^{2} - \frac{2 {X}_{d} {X}_{f}}{( n - 1 )}}{n}\end{matrix} \qquad ( 7 )$$

The generally known correlator output and received power are in a linear relationship, as shown in a formula (8). In this formula, a indicates a constant.

X_{d}=powd+a

X_{f}=powf+a (8)

The formula (8) is substituted in the formula (7), and can be represented by a relational expression of a formula (9).

$${σ}^{2} = \frac{{( powf + a )}^{2} + {( powd + a )}^{2} - \frac{2 ( powd + a ) ( powf + a )}{n - 1}}{n} \qquad ( 9 )$$

The number of samples n is 14 as shown in the formula (3). Further, powd shall be −81 dBm which is the minimum reception sensitivity in the UWB wireless communications. The powf is represented by the formula (6). The amount of delay spread is calculated by substituting these into a formula (9). The distribution of the delay spread calculated using the formula (9) will be the amount of delay spread. The amount of delay spread calculated from the simulation for example is shown in FIG. 2. The amount of delay spread is calculated for each piece of band information. Specifically, since the band information is the band ID or the band group, the amount of delay spread is calculated for each band ID or band group.

As shown in FIG. 2, there is a correlation that when the band ID signal increases, the amount of delay spread decreases. The overlap addition number is determined using the delay spread calculated by the relational expression of the formula (9). The determination of the overlap addition number depends on the environment to use the wireless communication. Thus the overlap addition number is determined assuming the environment with adverse conditions. As for the environment to use the wireless communication apparatus, a condition is assumed, for example there are more reflected waves when using the wireless communication apparatus in a smaller space than in a large space.

As mentioned above, the following steps are taken to determine the overlap addition number.

1. Step for calculating the propagation loss of waves in a free space using the formula (5).

2. Step for calculating the electric power of the reflected wave which reaches the reception apparatus using the formula (6).

3. Step for calculating the electric power of the direct wave which reaches the reception apparatus based on the minimum reception sensitivity in the UWB wireless communication.

4. Step for calculating the correlation value from the electric power of the reflected wave and the electric power of the direct wave using the formula (8).

5. Step for calculating the distribution (the amount of delay spread) of the delay spread using the formula (9).

6. Step for determining the overlap addition numbers according to the amount of delay spread.

The overlap addition number table unit 123 associates the band ID signal output from the MAC unit 122 with the overlap addition number determined using the relational expression of the formula (9). Then, the overlap addition number according to the amount of delay spread can be determined. The overlap addition number is determined by using the correlation between the band information and the amount of delay spread, as the result, the overlap addition number table unit 123 associates the band information and the overlap addition number.

The overlap addition number table unit 123 receives the band ID signal S0 as an input signal, and outputs the overlap addition number 51 value (values from zero to thirty-two). For example, for the band ID #1, the output value of overlap addition number 51 shall be thirty-two, and for the band ID #14, the output value of the overlap addition number 51 shall be four.

The combination of the overlap addition number for the band ID shown in FIG. 2 may be determined as appropriate by a simulation or LSI evaluation. The overlap addition number table unit 123 may take the band group information as the input signal, and determines the overlap addition number 51 value.

As described so far, the wireless communication apparatus of this embodiment includes a means to determine the overlap addition number using the overlap addition number table unit, from the signal of the band ID or the band group information indicating the frequency channel used in communications. The overlap addition number table unit is generated by the following procedure. An evaluation parameter (delay spread) is calculated by the delay spread estimation unit. The evaluation parameter is an index reflecting the spread of the time delay of the reception signal by the propagation of multipath of the reception signal. Then, the overlap addition number is calculated from the correlation of the band information and the amount of delay spread. According to the calculation result, the combination of the band information and the overlap addition number is determined. The overlap addition number table unit holds the combination of the band information and the overlap addition number which were determined in this way. The wireless communication apparatus determines the overlap addition number by the overlap addition number table unit. Therefore, the wireless communication apparatus does not need to calculate the amount of delay spread. This eliminates the need for the delay spread estimation unit and reduces the circuit size.

### Second Embodiment

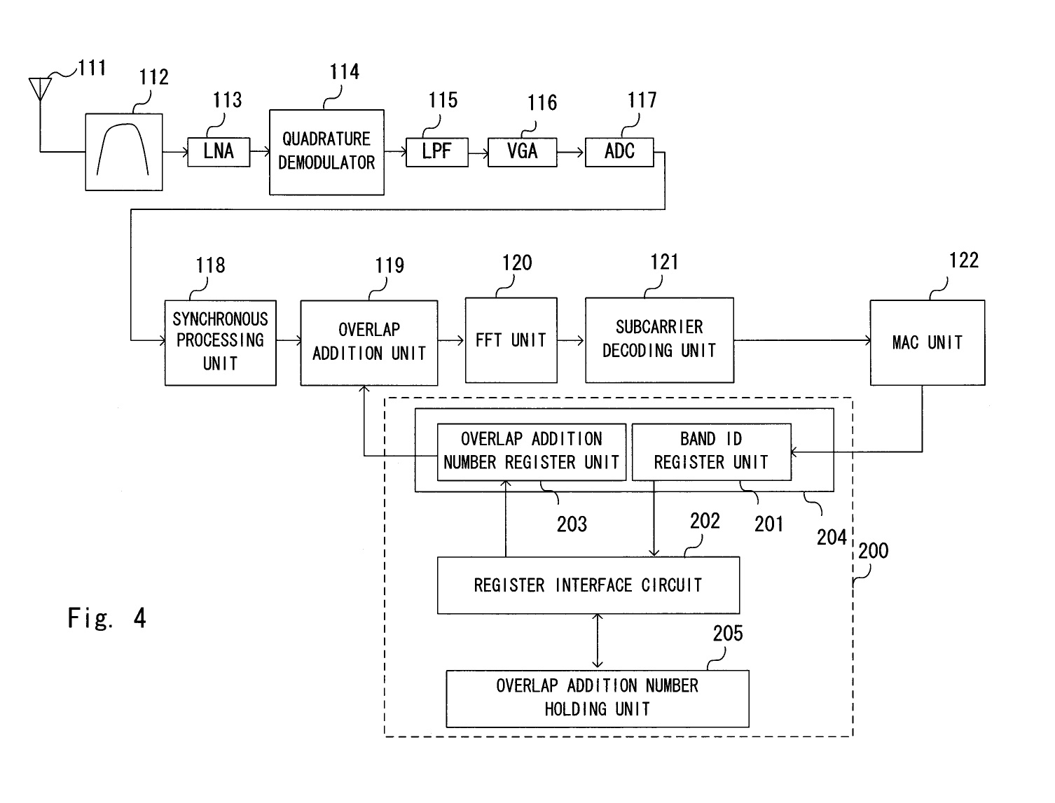

FIG. 4 is a block diagram showing a configuration example of a UWB reception apparatus according to a second embodiment of the present invention. Although FIG. 1 shows an example of the overlap addition number table unit 123 composed of hardware and placed in the LSI, FIG. 4 shows an example of the overlap addition number table unit 123 configured to be controlled from outside the LSI (configured with software for example).

As each component from the antenna 111 to the MAC unit 122 is same as FIG. 1, the explanation is omitted. In FIG. 4, an overlap addition number table unit 200 realizes the function corresponding to the overlap addition number table unit 123 of FIG. 1. The overlap addition number table unit 200 includes a register interface circuit 202, a resistor unit 204, and an overlap addition number holding unit 205. FIG. 4 shows the configuration example in which the register interface circuit 202 and the resistor unit 204 are placed inside the LSI, and the overlap addition number holding unit 205 is placed outside the LSI.

The resistor unit 204 is composed of a band ID register unit 201 that holds band IDs, and an overlap addition number resistor unit 203 that holds overlap addition numbers. The resistor unit 204 receives the band ID signal output from the MAC unit 122, and outputs the band ID signal held in the band ID register unit 201 to the register interface circuit 202. Further, the overlap addition number held in the overlap addition number register unit 203 is output to the overlap addition unit 119.

The register interface circuit 202 interfaces with outside to read and write data in the register unit 204. Specifically, the register interface circuit 202 reads the band ID held in the band ID register unit 201 and outputs the band ID to the overlap addition number holding unit 205. Moreover, the register interface circuit 202 receives the overlap addition number corresponding to the output band ID from the overlap addition number holding unit 205, and writes the overlap addition number to the overlap addition number resistor unit 203.

The overlap addition number holding unit 205 associates the band ID and the overlap addition number and holds them, receives the band ID from the register interface circuit 202, and outputs the overlap addition number corresponding to the band ID to the register interface circuit 202. The values calculated in a similar manner as the first embodiment are used for the band ID and the overlap addition number. The overlap addition number holding unit 205 may be realized by software or hardware.

A difference from the configuration of FIG. 1 in the operation of FIG. 4 is that the combination of the band ID and the overlap addition number held in the overlap addition number holding unit 205 can be controlled from outside the LSI by software or the like. For example, if the overlap addition number holding unit 205 is realized by software, the overlap addition number holding unit 205 stores the combination of the band ID and the overlap addition number beforehand in a memory. The overlap addition number holding unit 205 receives the band ID from the register interface circuit 202, and specifies the overlap addition number according to the band ID by searching in the memory. Then, the specified overlap addition number is output to the register interface circuit 202.

In the second embodiment, as described above, the combination of the band ID and the overlap addition number is controlled from outside the LSI. Accordingly, as in the first embodiment, the circuit size can be further reduced as compared to a case of holding the overlap addition number table unit 123 inside the LSI. Moreover, in the first embodiment, the overlap addition number is automatically determined by the operation of the hardware inside the LSI. Therefore, the overlap addition numbers are fixed to parameters determined at the time of manufacturing the LSI. On the other hand, in the second embodiment, as the overlap addition number is determined by the control from outside the LSI by software or the like, the parameter can be changed or adjusted even after manufacturing the LSI.

In the second embodiment, the case is explained in which the overlap addition number holding unit 205 is realized by software. However the overlap addition number holding unit 205 can be realized by hardware that is placed outside the LSI which is mounted with a wireless communication apparatus. The overlap addition number holding unit 205 may be the combination of software and hardware. Although, in the second embodiment, the band ID is used as the band information, it can be the band group as with the first embodiment.

### Other Embodiments

In the first embodiment, the case is explained in which the overlap addition number table unit 123 receives the band ID, however information that can specify the band ID may be notified. For example, the band group and a pattern number of the frequency hopping may be notified to the overlap addition number table unit 123. The overlap addition number table unit 123 can specify the band ID using the band group and the pattern number of frequency hopping.

In the first embodiment, it is assumed that the overlap addition number table unit 123 is composed of hardware. However the overlap addition number table unit 123 may be composed of software, or the combination of software and hardware. The wireless communication apparatus according to the present invention holds the combination of the band information and the overlap addition number in a memory. Then, the wireless communication apparatus includes a means to determine the overlap addition number from the band information using the combination held in the memory. The memory may either be a rewritable or non-rewritable storage area. For example, as in the first embodiment, if the overlap addition number table unit 123 is realized by hardware, the memory cannot be rewritten. Moreover in the second embodiment, if the overlap addition number holding unit 205, for example, holds the combination of the band information and the overlap addition number in the memory which can be rewritten from outside, the memory can be rewritten from outside. Further, when the overlap addition number holding unit 205 holds the combination of the band information and the overlap addition number in a non-rewritable memory, the memory cannot be rewritten.

In the second embodiment, before start using or while using the wireless communication apparatus, it is also possible to adjust the value held in the overlap addition number holding unit 205 of the overlap addition table unit 200. For example, after starting the communication using the wireless communication apparatus, communication characteristics are measured using a measurer. The overlap addition number is changed to a value (appropriate value) according to a measurement result so as to improve the communication characteristics. At this time, the appropriate value can be determined by repeating to measure the communication characteristics after changing the overlap addition number. The values held in the overlap addition number holding unit 205 are rewritten by an apparatus such as a calculator that can write to a memory and is connected to the memory.

Moreover, the signal processing realized by the wireless communication apparatus and explained in the above embodiments can be realized by a program. The program for processing the signal causes a computer to execute following processes. (1) A process to hold the combination of the band information and the overlap addition number in the memory, which associates the band information and the overlap addition number. The band information specifies the frequency band in which a signal is transmitted. The overlap addition number specifies the number of samples in the no-signal section which is to be overlap-added to the symbol. (2) A process to determine the overlap addition number according to the band information using the combination of the band information and the overlap addition number.

In the above example, the program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line or a wireless communication line.

According to either of the above-mentioned embodiments, the following advantageous effects can be achieved.

1) As a first effect, the circuit size can be reduced. The reason for that is that the overlap addition number table unit determines the overlap addition number according to the band information. The overlap addition number table holds the overlap addition number according to the delay spread calculated by the delay spread estimation unit of the related art for each piece of the band information. Specifically, an evaluation parameter (the amount of delay spread) is calculated by the delay spread estimation unit of the related art. The amount of delay spread reflects the spread of the time delay of the reception signal by the propagation of multipath of the reception signal. Then, the overlap addition number is calculated from the correlation of the band information and the amount of delay spread. The overlap addition number determined from the calculation result is associated with the band information so as to create the overlap addition number table unit. As the wireless communication apparatus according to the present invention determines the overlap addition number using the combination of the band information and the overlap addition number held in advance (overlap addition number table unit and overlap addition holding unit), it is not necessary to determine the overlap addition number according to the calculated delay spread. This eliminates the need for the delay spread estimation unit in the wireless communication apparatus, and thus the circuit size can be reduced.

2) As a second effect, power consumption can be reduced. The reason is that as the wireless communication apparatus according to the present invention can remove the delay spread estimation unit, the circuit size can be reduced and thereby reducing the power consumption.

The present invention is not limited to the above embodiments. Each element in the above embodiment can be modified, added, or converted into the content that can be easily understood by a person skilled in the art within the scope of the present invention.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above. Each of the embodiments can be combined as desirable by one of ordinary skill in the art.

Furthermore, it is noted that, Applicant's intent is to encompass equivalents of all claim elements, even if amended later during prosecution.

What is claimed is:

1. A wireless communication apparatus that receives a signal including a no-signal section inserted between OFDM (Orthogonal Frequency Division Multiplexing) symbols, the wireless communication apparatus comprising:
an overlap addition number table that associates band information and an overlap addition number, the band information specifying a frequency band to transmit a signal, and the overlap addition number specifying a number of samples in the no-signal section to be overlap-added to an OFDM symbol; and
an overlap addition unit that adds data to a beginning of the OFDM symbol using the overlap addition number table, the data corresponding to the overlap addition number determined according to the band information.

2. The wireless communication apparatus according to claim 1, wherein the overlap addition number table unit includes at least one of a band ID for specifying the frequency band and a band group composed of the plurality of band IDs as the band information.

3. The wireless communication apparatus according to claim 1, wherein the overlap addition number table associates the overlap addition number calculated according to the band information by using an amount of delay spread calculated beforehand which corresponds to each piece of the band information with the band information to be held.

4. The wireless communication apparatus according to claim 2, wherein the overlap addition number table associates the overlap addition number calculated according to the band information by using an amount of delay spread calculated beforehand which corresponds to each piece of the band information with the band information to be held.

5. The wireless communication apparatus according to claim 3, wherein the delay spread uses a value calculated by (1) calculating a propagation loss of a wave in a free space, (2) calculating electric power of a reflected wave that reaches the wireless communication apparatus, (3) calculating electric power of a direct wave that reaches a reception apparatus based on minimum reception sensitivity, (4) calculating a correlation value from the electric power of the reflected wave and the electric power of the direct wave, and (5) calculating distribution of a delay spread (an amount of the delay spread).

6. The wireless communication apparatus according to claim 4, wherein the delay spread uses a value calculated by (1) calculating a propagation loss of a wave in a free space, (2) calculating electric power of a reflected wave that reaches the wireless communication apparatus, (3) calculating electric power of a direct wave that reaches a reception apparatus based on minimum reception sensitivity, (4) calculating a correlation value from the electric power of the reflected wave and the electric power of the direct wave, and (5) calculating distribution of a delay spread (an amount of the delay spread).

7. The wireless communication apparatus according to claim 1, wherein the overlap addition number table unit is composed of hardware and outputs the overlap addition number to the overlap addition unit in response to an input of the band information.

8. The wireless communication apparatus according to claim 1, wherein the overlap addition number table unit stores a combination of the band information and the overlap addition number in a memory that can be rewritten from outside.

9. The wireless communication apparatus according to claim 1, wherein the overlap addition number table unit and the overlap addition unit are placed in one LSI (Large Scale Integration).

10. The wireless communication apparatus according to claim 1, wherein
the overlap addition number table unit comprises a memory that stores the combination of the band information and the overlap addition number, and
the memory is placed outside the LSI including the overlap addition unit.

11. The wireless communication apparatus according claim 1, further comprising a media access controller unit that processes decoded data, the decoded data being the decoded signal,
wherein the media access controller unit detects the band information from the decoded data.

12. A signal processing method of a wireless communication apparatus that receives a signal with a no-signal section inserted between OFDM symbols, the signal processing method comprising:
holding a combination of band information and an overlap addition number in a memory, the combination associating the band information that specifies a frequency band to transmit the signal and the overlap addition number that specifies a number of samples in the no-signal section to be overlap-added to an OFDM symbol; and
determining the overlap addition number according to the band information using the combination of the band information and the overlap addition number.

13. A non-transitory computer readable medium storing a program that when executed by a computer, causes the computer to execute a process for a wireless communication apparatus that receives a signal with no-signal section inserted between OFDM symbols to process the signal, the process comprising:
holding a combination of band information and an overlap addition number in a memory, the combination associating the band information that specifies a frequency band to transmit the signal with the overlap addition number that specifies a number of samples in the no-signal section to be overlap-added to an OFDM symbol; and
determining the overlap addition number according to the band information using the combination of the band
information and the overlap addition number.
